(19) United States
(12) Patent Application Publication
(10) Pub. No.: US 2018/0298843 A1
(43) Pub. Date: Oct. 18, 2018

(54) WASTE-HEAT RECOVERY SYSTEM AND METHOD FOR RECOVERY OF WASTE-HEAT

(71) Applicant: Chia-Wen Ruan, Nantou City (TW)

(72) Inventors: Chia-Wen Ruan, Nantou City (TW); I-Tang Wei, Nantou City (TW)

(21) Appl. No.: 15/485,903

(22) Filed: Apr. 12, 2017

(51) Int. Cl. F02G 1/05; F02G 1/053; F01K 23/06

(52) U.S. Cl. CPC F02G 1/05; F01K 23/06; F02G 1/053

(57) ABSTRACT

A waste-heat recovery system includes a main power unit, an auxiliary power unit and a transmission unit. The main power unit includes a main engine, a main output shaft that is driven by the main engine, and a heat pipe that is connected to the main engine. The auxiliary power unit includes a stirling engine that is connected to the heat pipe, and an transmission shaft that is driven by the stirling engine. The transmission unit is disposed between the main output shaft and the transmission shaft for transmitting torque from the transmission shaft to the main output shaft.

### FIELD

The disclosure relates to an engine, and more particularly to a waste-heat recovery system.

### BACKGROUND

A conventional power system for driving a propeller of a ship includes a main engine, and a main shaft that is driven by the main engine and that is connected to the propeller. The main engine drives the propeller via the main shaft for moving the ship.

However, during the operation of the conventional power system, the heat generated by the main engine is not used, and may be wasted, and the main engine may therefore have relatively great fuel consumption.

### SUMMARY

Therefore, an object of the disclosure is to provide a waste-heat recovery system that can alleviate at least one of the drawbacks of the prior art.

According to the disclosure, the waste-heat recovery system includes a main power unit, an auxiliary power unit and a transmission unit. The main power unit includes a main engine, a main output shaft that is driven by the main engine, and a heat pipe that is connected to the main engine. The auxiliary power unit includes a stirling engine that is connected to the heat pipe, and a transmission shaft that is driven by the stirling engine. The transmission unit is disposed between the main output shaft and the transmission shaft for transmitting torque from the transmission shaft to the main output shaft.

Another object of the disclosure is to provide a method for recovery of waste-heat that can alleviate the drawback of the prior art.

According to the disclosure, the method for recovery of waste-heat includes steps of: a) driving a main output shaft to rotate in a first rotational direction by a main engine for rotating the main output shaft at a predetermined speed, and detecting the torque of the main output shaft by a first torque sensor as an initial torque when the rotational speed of the main output shaft reaches the predetermined speed; b) receiving the heat generated by the main engine by a stirling engine to drive rotation of a transmission shaft in the first rotational direction, and transmitting the torque of the transmission shaft to the main output shaft by virtue of a transmission unit; c) detecting the rotational speed of the transmission shaft by a speed sensor; and d) adjusting a gear ratio of a gearbox connected between the stirling engine and the transmission shaft by a control unit for adjusting the rotational speed of the transmission shaft to an objective speed, the objective speed being greater than the predetermined speed and smaller than a sum of the predetermined speed and a predetermined speed offset.

### BRIEF DESCRIPTION OF THE DRAWINGS

Other features and advantages of the disclosure will become apparent in the following detailed description of the embodiment with reference to the accompanying drawings, of which:

FIG. 1 is a schematic view illustrating an embodiment of the waste-heat recovery system according to the disclosure;

FIG. 2 is a block diagram illustrating the embodiment; and

FIG. 3 is a flowchart illustrating steps of a method for recovery of waste-heat according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

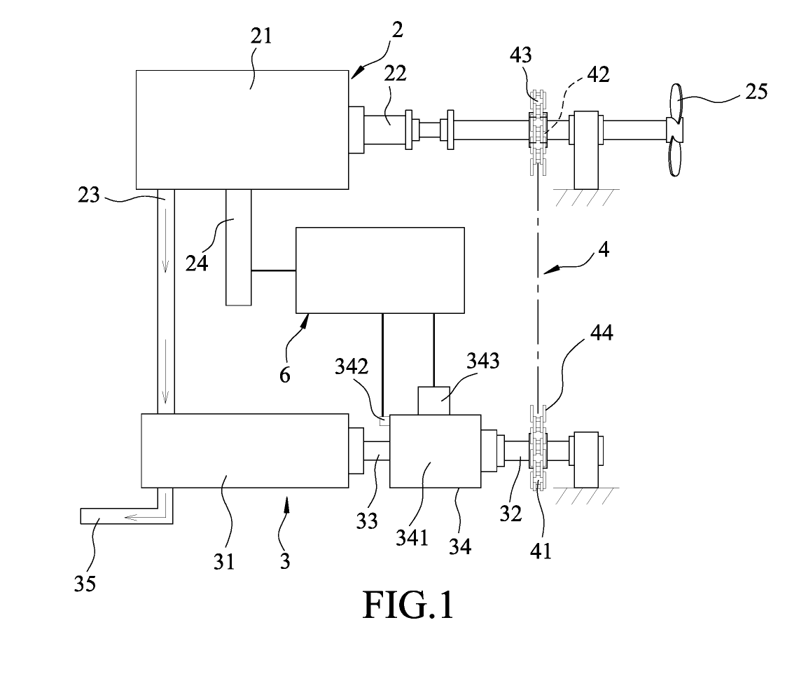

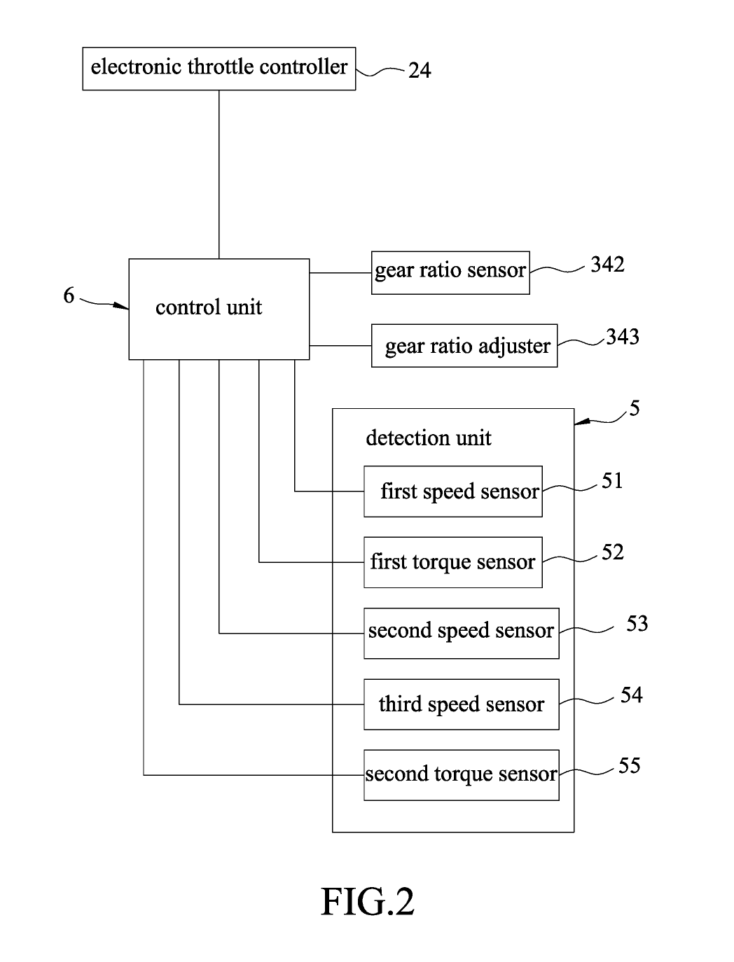

Referring to FIGS. 1 and 2, the embodiment of the waste-heat recovery system according to the disclosure includes a main power unit 2, an auxiliary power unit 3, a transmission unit 4, a detection unit 5 and a control unit 6.

The main power unit 2 includes a main engine 21, a main output shaft 22 that is driven by the main engine 21, a heat pipe 23 that is connected to the main engine 21, and an electronic throttle controller 24 that is connected to the main engine 21 and that is electrically coupled to the control unit 6 for adjusting the fuel feed rate of the main engine 21.

The auxiliary power unit 3 includes a heat engine 31 that is connected to the heat pipe 23, an auxiliary output shaft 33 that is driven by the heat engine 31, a transmission shaft 32, a gearbox module 34 that is connected between the transmission shaft 32 and the auxiliary output shaft 33, and an exhausting tube 35 that is connected to the heat engine 31. In this embodiment, the heat engine 31 is configured as a stirling engine that receives the heat generated by the main engine 21 via the heat pipe 23, and that expels low-temperature air into a heat sink via the exhausting tube 35.

The gearbox module 34 includes a gearbox 341 that is connected between the transmission shaft 32 and the auxiliary output shaft 33, a gear ratio sensor 342 that is connected to the gearbox 341 and that is electrically coupled to the control unit 6 for detecting the gear ratio of the gearbox 341, and a gear ratio adjuster 343 that is electrically coupled to the control unit 6 for adjusting the gear ratio of the gearbox 341. In this embodiment, the gearbox 341 is switched by the gear ratio adjuster 343 among different positions to adjust the gear ratio thereof, and the gear ratio sensor 342 detects the position of the gearbox 341 so as to determine the gear ratio of the gearbox 341.

The transmission unit 4 is disposed between the main output shaft 22 and the transmission shaft 32 for transmitting torque from the transmission shaft 32 to the main output shaft 22. The transmission unit 4 includes a first transmission gear 41 that is mounted to the transmission shaft 32, a one-way bearing 42 that is mounted to the main output shaft 22, a second transmission gear 43 that is mounted to the one-way bearing 42, and a transmission chain 44 that is trained on the first transmission gear 41 and the second transmission gear 43. The one-way bearing 42 is configured such that the second transmission gear 43 is non-rotatable relative the main output shaft 22 in a first rotational direction (i.e., the second transmission gear 43 is co-rotatable with the main output shaft 22 in the first rotational direction), and is rotatable relative to the main output shaft 22 in a second rotational direction opposite to the first rotational direction. The first and second transmission gears 41, 43 have the same number of teeth.

The detection unit 5 includes a first speed sensor 51 for detecting the rotational speed of the main output shaft 22, a first torque sensor 52 for detecting the torque of the main output shaft 22, a second speed sensor 53 for detecting the rotational speed of the auxiliary output shaft 33, a third speed sensor 54 for detecting the rotational speed of the transmission shaft 32, and a second torque sensor 55 for detecting the torque of the transmission shaft 32.

The control unit 6 is electrically coupled to the electronic throttle controller 24, the gear ratio sensor 342, the gear ratio adjuster 343, the first speed sensor 51, the first torque sensor 52, the second speed sensor 53, the third speed sensor 54 and the second torque sensor 55. The control unit 6 determines a gear ratio based on the rotational speed of the main output shaft 22 and the rotational speed of the auxiliary output shaft 33 respectively detected by the first and second speed sensors 51, 53, and then adjusts the gear ratio of the gearbox module 34 to the determined gear ratio so as to adjust the rotational speed of the transmission shaft 32.

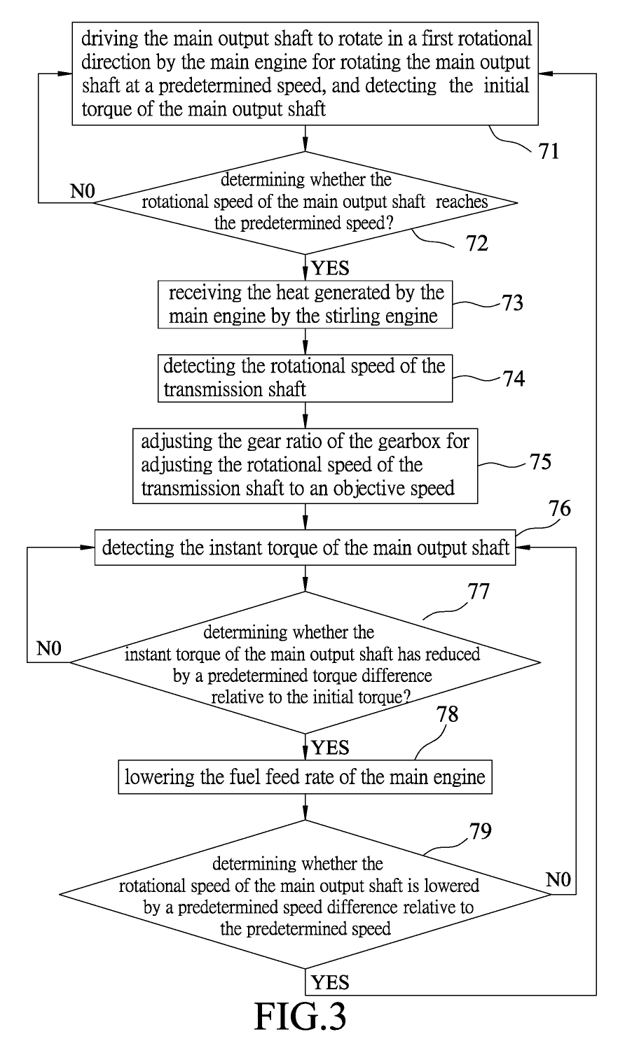

FIG. 3 is a flowchart illustrating steps of a method for recovery of waste-heat according to the disclosure.

In step 71, the main engine 21 drives the main output shaft 22 to rotate in the first rotational direction for rotating the main output shaft 22 at a predetermined speed, and the first torque sensor 52 detects the torque of the main output shaft 22 as an initial torque when the rotational speed of the main output shaft 22 reaches the predetermined speed.

In step 72, the first speed sensor 51 detects the rotational speed of the main output shaft 22, and the control unit 6 determines whether the rotational speed of the main output shaft 22 reaches the predetermined speed. When it is determined that the rotational speed of the main output shaft 22 does not reach the predetermined speed, the flow goes back to step 71. Otherwise, the flow proceeds to step 73.

In step 73, the heat engine 31 receives the heat generated by the main engine 21 to drive rotation of the auxiliary output shaft 33, so as to drive rotation of the transmission shaft 32 in the first rotational direction for transmitting the torque of the transmission shaft 32 to the main output shaft 22 via the transmission unit 4.

In step 74, the third speed sensor 54 detects the rotational speed of the transmission shaft 32.

In step 75, the control unit 6 adjusts the gear ratio of the gearbox 431 for adjusting the rotational speed of the transmission shaft 32 to an objective speed. The objective speed is greater than the predetermined speed and is smaller than a sum of the predetermined speed and a predetermined speed offset.

In step 76, the first torque sensor 52 detects the instant torque of the main output shaft 22.

In step 77, the control unit 6 determines whether the instant torque of the main output shaft 22 has reduced relative to the initial torque by a predetermined torque difference. When it is determined that the instant torque of the main output shaft 22 has not reduced by the predetermined torque difference, the flow goes back to step 76. Otherwise, the flow proceeds to step 78.

In step 78, the control unit 6 controls the electronic throttle controller 24 to lower the fuel feed rate of the main engine 21.

In step 79, the first speed sensor 51 detects the instant rotational speed of the main output shaft 22, and the control unit 6 determines whether the instant rotational speed of the main output shaft 22 is lowered relative to the predetermined speed by a predetermined speed difference. When it is determined that the instant rotational speed of the main output shaft 22 has not been lowered by the predetermined speed difference, the flow goes back to step 76. Otherwise, the flow goes back to step 71.

For instance, in this embodiment, the main output shaft 22 is for driving rotation of a propeller 25 (see FIG. 1) mounted thereon in the first rotational direction. The predetermined speed is 3000 revolutions per minute (rpm). The main engine 21 first drives rotation of the main output shaft 22 in the first rotational direction and adjusts the rotational speed of the main output shaft 22 until the rotational speed of the main output shaft 22 reaches the predetermined speed. When the main output shaft 22 is rotated at the predetermined speed (i.e., 3000 rpm), the torque of the main output shaft 22 detected by the first torque sensor 52 is determined as the initial torque. Then, the heat engine 31 receives the heat generated by the main engine 21 to drive rotation of the auxiliary output shaft 33 at a rotational speed of 2003 rpm, so as to drive rotation of the transmission shaft 32 in the first rotational direction via the gearbox 341. The control unit 6 adjusts the gear ratio of the gearbox 431 based on the rotational speed of the transmission shaft 32 and the predetermined speed for adjusting the rotational speed of the transmission shaft 32 to the objective speed. The predetermined speed offset herein is 10 rpm, so the objective speed may be 3005 rpm. The control unit 6 thus adjust the gear ratio of the gearbox to 1:1.5.

The transmission shaft 32 then drives the first transmission gear 41 to rotate at 3005 rpm, so as to drive the second transmission gear 43 to rotate in the first rotational direction at 3005 rpm via the first transmission gear 41 and the transmission chain 44. Since the one-way bearing 42 is configured such that the second transmission gear 43 is co-rotatable with the main output shaft 22 in the first rotational direction, and since the rotational speed of the second transmission gear 43 in the first rotational direction is greater than that of the main output shaft 22, the second transmission gear 43 drives the main output shaft 22 to transmit the torque of the transmission shaft 32 onto the main output shaft 22. At this time, the main engine 21 applies a smaller torque to the main output shaft 22 in order to maintain the main output shaft 22 to rotate at the predetermined speed. When the instant torque of the main output shaft 22 has reduced by the predetermined torque difference relative to the initial torque, the heat engine 31 has provided a sufficient torque to the main output shaft 22. Therefore, the control unit 6 controls the electronic throttle controller 24 to lower the fuel feed rate of the main engine 21 so as to lower the rotational speed of the main output shaft 22, and to reduce the fuel consumption of the main engine 21.

It should be noted that since the one-way bearing 42 is configured such that the second transmission gear 43 is rotatable relative the main output shaft 22 in the second rotational direction, when the rotational speed of the second transmission gear 43 in the first rotational direction is smaller than that of the main output shaft 22, the second transmission gear 43 is rotatable relative the main output shaft 22 and does not transmit the torque thereof onto the main output shaft 22.

In summary, by virtue of the main power unit 2, the auxiliary power unit 3 and the transmission unit 4, the heat generated by the main engine 21 can be used to provide an additional torque to the main output shaft 22, so as to reduce the fuel consumption of the main engine 21.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A waste-heat recovery system comprising:
a main power unit including a main engine, a main output shaft that is driven by said main engine, and a heat pipe that is connected to said main engine;
an auxiliary power unit including a stirling engine that is connected to said heat pipe, and an transmission shaft that is driven by said stirling engine; and
a transmission unit disposed between said main output shaft and said transmission shaft for transmitting torque from said transmission shaft to said main output shaft.

2. The waste-heat recovery system as claimed in claim 1, wherein said auxiliary power unit further includes an auxiliary output shaft that is driven by said stirling engine and that is connected between said stirling engine and said transmission shaft, and a gearbox module that is connected between said transmission shaft and said auxiliary output shaft.

3. The waste-heat recovery system as claimed in claim 2, further comprising a detection unit and a control unit, said detection unit including a first speed sensor for detecting the rotational speed of said main output shaft, a first torque sensor for detecting the torque of said main output shaft, a second speed sensor for detecting the rotational speed of said auxiliary output shaft, a third speed sensor for detecting the rotational speed of said transmission shaft, and a second torque sensor for detecting the torque of said transmission shaft, said control unit being electrically coupled to said gearbox module, said first speed sensor, said first torque sensor, said second speed sensor, said third speed sensor and said second torque sensor, said control unit determining a gear ratio based on the rotational speed of said main output shaft and the rotational speed of said auxiliary output shaft, and then adjusting the gear ratio of said gearbox module to the determined gear ratio so as to adjust the rotational speed of said transmission shaft.

4. The waste-heat recovery system as claimed in claim 3, wherein said gearbox module includes a gearbox connected between said transmission shaft and said auxiliary output shaft, a gear ratio sensor that is connected to said gearbox and that is electrically coupled to said control unit for detecting the gear ratio of said gearbox, and a gear ratio adjuster that is electrically coupled to said control unit for adjusting the gear ratio of said gearbox.

5. The waste-heat recovery system as claimed in claim 4, wherein said main power unit further includes an electronic throttle controller that is connected to said main engine and that is electrically coupled to said control unit for adjusting the fuel feed rate of said main engine.

6. The waste-heat recovery system as claimed in claim 5, wherein said transmission unit includes a first transmission gear that is mounted to said transmission shaft, a one-way bearing that is mounted to said main output shaft, a second transmission gear that is mounted to said one-way bearing, and a transmission chain that is trained on said first transmission gear and said second transmission gear.

7. A method for recovery of waste-heat, comprising steps of:
a) driving a main output shaft to rotate in a first rotational direction by a main engine for rotating the main output shaft at a predetermined speed, and detecting the torque of the main output shaft by a first torque sensor as an initial torque when the rotational speed of the main output shaft reaches the predetermined speed;
b) receiving the heat generated by the main engine by a stirling engine to drive rotation of a transmission shaft in the first rotational direction, and
transmitting the torque of the transmission shaft to the main output shaft by virtue of a transmission unit;
c) detecting the rotational speed of the transmission shaft by a speed sensor; and
d) adjusting a gear ratio of a gearbox connected between the stirling engine and the transmission shaft by a control unit for adjusting the rotational speed of the transmission shaft to an objective speed, the objective speed being greater than the predetermined speed and smaller than a sum of the predetermined speed and a predetermined speed offset.

8. The method of claim 7, further comprising, after step d), steps of:
e) detecting the instant torque of the main output shaft by the torque sensor;
f) when it is determined that the instant torque of the main output shaft has not reduced by a predetermined torque difference relative to the initial torque, repeating step e); and
g) when it is determined that the instant torque of the main output shaft has reduced by a predetermined torque difference relative to the initial torque, controlling an electronic throttle controller by the control unit to lower the fuel feed rate of the main engine.

9. The method of claim 8, further comprising, between steps a) and b), a step of:
h) detecting the rotational speed of the main output shaft by an additional speed sensor, and determining whether the rotational speed of the main output shaft reaches the predetermined speed;
wherein when it is determined that the rotational speed of the main output shaft does not reach the predetermined speed, repeat sep a); and
wherein when it is determined that the rotational speed of the main output shaft reaches the predetermined speed, execute step b).

10. The method of claim 9, further comprising, after step g), steps of:
i) detecting the rotational speed of the main output shaft by the additional speed sensor, and determining whether the rotational speed of the main output shaft is lowered by a predetermined speed difference relative to the predetermined speed;
wherein when it is determined that the rotational speed of the main output shaft has not been lowered by the predetermined speed difference, execute step e); and
wherein when it is determined that the rotational speed of the main output shaft has been lowered by the predetermined speed difference, execute step a).
